(19) United States
(12) Patent Application Publication
(10) Pub. No.: US 2026/0054630 A1
(43) Pub. Date: Feb. 26, 2026

(54) ABRASION RESISTANT PAD FOR AN AUTOMOTIVE FLOORING SYSTEM

(71) Applicant: AUTONEUM MANAGEMENT AG, Winterthur (CH)

(72) Inventors: Philippe GODANO, Winterthur (CH); Stefano SCHNAPPENBERGER, Winterthur (CH)

(73) Assignee: AUTONEUM MANAGEMENT AG, Winterthur (CH)

(21) Appl. No.: 19/104,472

(22) PCT Filed: Aug. 11, 2023
(86) PCT No.: PCT/EP2023/072280

§ 371 Date: Feb. 18, 2025

(30) Foreign Application Priority Data
Aug. 23, 2022 (EP) 22191793.3

(51) Int. Cl. B60N 3/04

(52) U.S. Cl. CPC B60N 3/048

(57) ABSTRACT

An abrasion resistant pad for an automotive floor covering, characterised in that the pad comprises at least one layer comprising a thermoplastic polyester elastomer (TPEE) material comprising crystalline polyesters and amorphous polyethers.

This application is a national stage application under 35 U.S. C. 371 and claims the benefit of PCT Application No. PCT/EP2023/072280, having an international filing date of Aug. 11, 2023, which designated the United States, which PCT application claimed the benefit of European Patent Application No. EP22191793.3, filed Aug. 23, 2022, the disclosure of each of which are incorporated by reference herein.

### TECHNICAL FIELD

The present invention relates to automotive flooring systems and flooring mats incorporating abrasion-resistant strips.

### BACKGROUND ART

Automotive flooring systems and car mats are especially subject to wear in those areas where moving parts, in particular passenger or driver's heels, make contact with the carpet surface. It is therefore common to include an abrasion resistant strip in the areas affected.

On the flooring system and or the floor mat additional pads or inlays may be inserted or applied locally on the surface locally in areas prone to high abrasion to obtain a strengthened area. An example for such patches or inlays are heel pads. These are traditional made of polyvinyl chloride (PVC).

These local pads do not only serve the purpose of reducing abrasion damage, but may also supply an anti-slip surface to prevent the foot from sliding of the pedal during driving.

Automotive flooring parts and floor mats are complex produced trim parts with multiple layers and accessories to comply with all necessary requirements for such a part. These trim parts may be molded in a 3D shape to comply with the surface underneath.

The trim part covering the main flooring of a vehicle or the thrown-in floor mats might have a tufted or nonwoven carpet system surface. The industry strives to replace these multilayer systems based on mixed plastic materials for a substantially mono-material layering based on polyesters, preferably terephthalate based polyesters.

This has the advantage, that the production related waste, like cut offs and faulty parts and end of life waste of such flooring parts or the mats may be recycled without the need of material separation. Hence, pollution caused by materials not belonging to the polyester family are avoided during the recycling process. Such pollution can cause a reduction in recycled material quality. It might result in a material mix not acceptable for established recycling processes, and might end up in incineration or landfill.

Abrasion resistant or protective strips or pads seem to be neglected in the overall recycling concept of automotive trim parts containing them. As the current abrasion resistant or protective strips or pads are still made from poly vinyl chloride (PVC). Although PVC on its own may be recycled or retain recycled material, it reduces the overall quality, process ability or value of waste material, like process related waste and end of life parts, when combined or mixed with polyester based material.

A major problem in the recycling of PVC is the high chlorine content in raw PVC (around 56 percent of the polymer's weight) and the high levels of hazardous additives added to the polymer to achieve the desired material quality. As a result, PVC requires separation from other plastics even before mechanical recycling. As these pads, like the heel pad, are welded or adhered firmly to the carpet surface of the flooring part or mat separation is near to impossible without contamination of the one or other material layer.

Hence, although the main flooring system may be directed to polyester based mono-materials to enable an efficient recycling, the accessories used are not compliant with this overall direction.

So far, the industry has struggled to find alternatives that are satisfying the necessary requirements and that can be included in the overall recycling of the flooring system, such that the need of removing or disassembling them from the part is eliminated and/or any contamination is not devaluating the recycling feedstock.

It is the goal to provide an alternative solution for the abrasion resistant pads to increase the recyclability of trim parts including such pads, and in particular, to reduce separation steps and waste streams.

### SUMMARY OF INVENTION

The present invention provides an abrasion resistant pad according to claim 1 and trim parts comprising such pads as well as the use of such a pad.

An abrasion-resistant pad for an automotive floor covering, characterized in that the pad comprises at least one layer comprising a thermoplastic polyester elastomer (TPEE) material comprising crystalline polyesters and amorphous polyethers.

The polyester elastomer is preferably terephthalate based, preferably one of poly(butylene terephthalate) (PBT) or poly(ethylene terephthalate)(PET).

The amorphous polyether is preferably one of poly(tetra methylene ether glycol terephthalate) or poly(alkylene glycol).

The heel pad may be extruded or injection molded. The surface may be embossed or grained to increase the surface roughness and improve the anti-slip properties, as well as to prevent water or dirt from reducing the same. Furthermore, the pad may be formed to fit in a recess in the underlying flooring or mat part, or to follow a curvature or 3 D shape.

The pad according to the invention may be used as a loose single layer mat to replace classic PVC mats for floor protection, or may be used as a local pad or strip on a floor mat or integrated flooring system in a car. In both cases it may be attached by mechanical or chemical means to the surface of the part, this may be a polyester nonwoven or tufted carpet layer comprising polyester based fibers or yarn. Preferably the pad is thermally welded to the surface of the flooring system or pad.

Alternatively, a strip of the abrasion pad is placed at a border area of the mat or flooring part where the legs or the foot scuff or rest as well as the area where the heels of the driver and/or passenger(s) make contact with the mat.

The pad is comprising a thermoplastic polyester elastomer (TPEE) comprising hard segments comprising of crystalline polyesters, preferably poly(butylene terephthalate) (PBT) or poly(ethylene terephthalate) (PET), and soft segments comprising of amorphous polyethers such as poly(tetra methylene ether glycol terephthalate) or poly(alkylene glycol).

Preferably, it may be blended with crystalline and/or amorphous polyesters to further enhance properties. For instance, it may be blended with PBT to optimize thermal and mechanical properties. Commercial examples that may be used according to the invention may be DuPont™ Hytrel® TPC-ET or DuPont™ Crastin® PBT, or DSM Arnitel, or Keyflex, which is a combination of crystalline PBT and PTMEG amorphous polyether.

The preferred material may comprise low amount of fillers up to 10% to optimize the properties and or to reduce overall cost of the part. Fillers may be at least one of an inert particle or fiber filler, for instance CaCO₃, MICA, clay, or any of natural, synthetic or mineral fibers may be used.

The preferred material for the pad may further comprise any additives that may enhance either the quality appearance or may aid in the production process, like UV blocking additives and or color dyes, like carbon black.

Preferably, the TPEE based material of the pad has a hardness of between 65 and 90 shore A, preferably between 70 and 80 Shore A, as measured with DIN 53 505 10″.

Preferably, the TPEE based material of the pad has a tensile strength of at least 10 N/mm².

The crystalline polyester and or amorphous polyether may come from a biobased material or from a recycled resource. It may also come from a mixed resource to partially replace oil based products with either biobased or recycled content, to further optimize the environmental footprint.

A pad based on the TPEE material according to the invention may be used as a floor mat, trunk mat, or front trunk mat in a vehicle. These are mats that are put loosely on top of the flooring system or floor mat. These mats may be attached locally by a mechanical attachment like a clip, male-female means for attachment that may be pushed together or similar attachments as known in the art.

An automotive flooring system or floor mat with at least a nonwoven or a tufted carpet layer comprising at least one pad based on the TPEE material according to the invention.

An automotive flooring system is defined as an automotive trim part that is shaped, for instance by molding to fit inside the passenger compartment to cover at least part of the main floor area. This might extended to include at least part of the inner dash and or adjacent vertical side areas of the passenger compartment. Preferably, a pad or strip of the TPEE material according to the invention may be used on areas of the foot well in particular where the feet or heel of driver or passengers would likely touch the flooring system. This might also be pads or strips along the side wall where the side of the shoes may scuff against. In general, it may be used on top of all surfaces that may be prone to more intensive abrasion.

The at least one pad may be attached to the carpet surface of the flooring system or to the floor mat surface. The pad may be attached by any known mechanically, chemical or thermal method used normally for attaching for instance a heel pad to a carpet surface. This may be mechanical, for instance clips, sewing or stapling, thermally attached to the carpet surface, like with a welding operation, or during molding of the part, or materially attached to the carpet surface, like glued or chemically welded. The pad may be either point bonded, partially bonded or bonded over the full surface of the pad. Preferably, the pad is attached after the molding of the automotive flooring system or floor mat and thermally welded in a pattern of dots or stripes to the surface facing the passenger compartment.

An automotive flooring system or floor mat may further comprise a surface based on a nonwoven or tufted carpet comprising polyester, polyamide or a polyolefin. Preferably, the carpet layer comprises a terephthalate based polyester, like PET and or PBT. Which would be compatible with the main material for the heel mat and would make the recycling easier and increase the quality of the obtained waste.

An automotive flooring system or floor mat may further comprise at least a fibrous backing layer comprising polyester fibers. Also for the backing layer it is preferred to use terephthalate based fibers, preferably PET or PBT, preferably consisting of polyester fibers.

The automotive flooring system or floor mat with a carpet surface layer covered at least partially with a pad or strip based on TPEE material according to the invention may further comprise a least one additional layer, preferably at least one of a highly filled thermoplastic elastomeric layer, a foil layer, a foam layer, a nonwoven layer or scrim layer or a textile layer, like a woven or knit layer.

In general, in all instances polyester is used in either the carpet surface or any of the initial layers, the polyester is preferably up to 100% from a recycled source and or bio-based source.

Surprisingly a TPEE material based pad is able to resist abrasion, while a polyester, preferably terephthalate based flooring part, floor mat or cut off or rejected parts with this combination may be recycled without the need for separation of the different layers-the pad of strip-and the flooring part or other layers.

### BRIEF DESCRIPTION OF DRAWINGS

FIG. 1 schematic flooring system with a heel pad according to the invention.

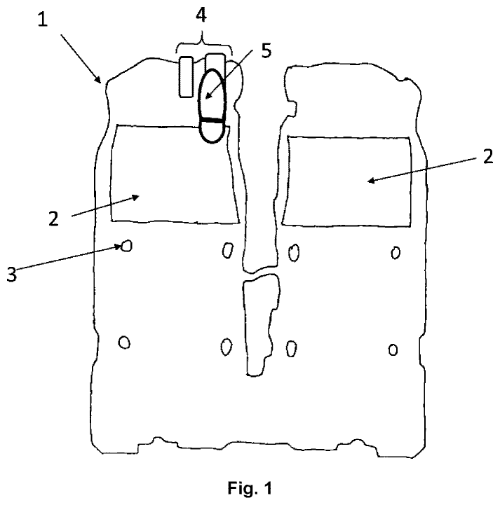

### DETAILED DESCRIPTION

A flooring system 1 comprising a nonwoven or tufted terephthalate based polyester surface and polyester based backing layer (not shown), laminated together, further comprising a heel pad 2 comprising a thermoplastic polyester elastomer (TPEE) material comprising crystalline polyesters and amorphous polyethers. The heel pad is placed such that the foot of the driver 5 may serve the pedals 4 while staying in touch with the heel pad, thereby eliminating any scuffing on the main floor part as well as preventing any slippage of the foot during interaction.

The surface of the insert or pad may be molded and may include an surface embossment or graining. The lower surface of the insert or pad may be embossed with a pin type shape to obtain a better grip on the carpet surface underneath.

1. An abrasion resistant pad for an automotive floor covering, characterized in that the pad comprises at least one layer comprising a thermoplastic polyester elastomer (TPEE) material comprising crystalline polyester and amorphous polyester.

2. The pad according to claim 1, whereby the crystalline polyester is a terephthalate based polyester.

3. The pad according to claim 1, whereby the amorphous polyester is one of poly(tetra methylene ether glycol terephthalate) or poly(alkylene glycol).

4. The pad according to claim 1, whereby an outer surface comprises an embossed or grained pattern.

5. The pad according to claim 1, whereby the thermoplastic polyester elastomer material further comprises CaCO₃ or mica fillers, UV blocking additives, and/or color dyes.

6. The pad according to claim 1, whereby the at least one layer has a hardness of between 65 and 90 shore A, as measured with DIN 53 505 10″.

7. The pad according to claim 1, whereby the crystalline polyester and or amorphous polyether is at least partially bio-based or from a recycled resource.

8. A method of using of the pad according to claim 1 as a floor mat, trunk mat, or front trunk mat in a vehicle.

9. An automotive flooring system or floor mat with at least a nonwoven or a tufted carpet layer comprising at least one pad according to claim 1.

10. The automotive flooring system or floor mat according to claim 9, whereby the at least one pad is mechanically attached to the carpet layer or materially attached to the carpet layer.

11. The automotive flooring system or floor mat according to claim 10, whereby the at least one pad is point bonded, partially bonded, or bonded over the full surface of the carpet.

12. The automotive flooring system or floor mat according to claim 9, whereby the nonwoven or tufted carpet comprises polyester, preferably comprising PET and or PBT, polyamide, or polyolefin, like polypropylene.

13. The automotive flooring system or floor mat according to claim 9, further comprising at least a fibrous backing layer comprising polyester fibers polyester

14. The automotive flooring system or floor mat according to claim 9, further comprising a least an additional layer, a foil layer, a foam layer, and a nonwoven fibrous layer, a scrim layer, or a textile layer.

15. The automotive flooring system or floor mat according to claim 9, whereby the polyester for the carpet layer and or backing layer is up to 100% from a recycled source.
